(19) United States
(12) Patent Application Publication
(10) Pub. No.: US 2007/0065021 A1
(43) Pub. Date: Mar. 22, 2007

(54) System for encoding signatures for compressed storage using a signature encoding algorithm

(76) Inventors: David Delgrosso, Naperville, IL (US); Fraser Orr, Naperville, IL (US); Jason Shaver, Bolingbrook, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/486,444

(22) Filed: Jul. 13, 2006

Related U.S. Application Data
(60) Provisional application No. 60/699,131, filed on Jul. 14, 2005.

(51) Int. Cl. G06K 9/36; G06K 9/00

(52) U.S. Cl. 382/232; 382/119

(57) ABSTRACT

A method of encoding markings, such as handwritten signatures includes the steps of mapping the markings for each line by creating a line profile for each line, sorting the line profiles into at least two arrays distinguished from each other by at least one characteristic contained in each line profile, optimizing the at least two arrays by reducing redundant line profiles, and converting the at least two arrays into code.

### CROSS REFERENCE TO RELATED APPLICATION

This Application claims priority on U.S. Provisional Patent Application No. 60/699,131 filed on Jul. 14, 2005, which is herein incorporated by reference.

### TECHNICAL FIELD

The present invention relates to encoding writings, and in particular, encoding signatures.

### BACKGROUND OF THE INVENTION

Authenticating signatures electronically can be important. The information can be stored and used for future reference. Such encoded information can be used as a permanent electronic record and as a basis for later comparison. Specifically, a first encoded signature can be compared with a second encoded signature to determine if they are similar or not similar. In addition, once encoded, the code can be decoded so as to reconstruct or reproduce the a signature.

### SUMMARY OF THE INVENTION

The present process is for encoding signatures in a secure seal, such as on a bank check so as to provide portable positive pay for vendors. An algorithm is employed describing the procedures for encoding the signature presented in a small area. It is envisioned that vendors can check the validity of a signature by comparing the one encoded signature with another signature.

Such a system includes a check scanner for reading the encoded signatures and for comparing the encoded signatures to the written signature. The comparison results in a sorting of the checks into three (3) categories—(a) good, (b) bad, and (c) inconclusive/unsure.

The present invention is generally a method for encoding markings having a plurality of lines therein, such as texts, handwritten or typed. It is particularly suited for use with handwriting and signatures which have characteristics specific to individuals.

According to a first aspect of the invention, the method of encoding includes the steps of mapping the markings for each line by creating a line profile for each line, sorting the line profiles into at least two arrays distinguished from each other by at least one characteristic contained in each line profile, optimizing the at least two arrays by reducing redundant line profiles, and converting the at least two arrays into code.

According to another aspect, each line profile comprises a line direction, a line start location coordinates and a line length. In addition, the one characteristic for sorting the line profiles is preferably the line direction so that each array includes line profiles having the same line directions.

According to a further aspect of the invention, the step of optimizing the arrays includes reducing redundant line profiles by first ranking the arrays so as to create a primary array and at least one secondary array. One can then remove each line profile from the secondary array(s) having a line length of one. Next, one can remove each line profile from the primary array having a line length of one and duplicated in the secondary array(s). Finally, one can remove each line profile from the secondary array(s) that is duplicated in the primary array.

According to a still further aspect of the present invention, the step of converting the at least two arrays into code includes the steps of sorting each array based upon line length, combining the arrays by stacking the primary array and then the secondary array(s) to create a single array, converting the line profiles to a plurality of bit patterns of a pre-selected length, combining the bit patterns of the single array to create a cumulative bit string, grouping the cumulative bit string into separate substrings, and converting the separate substrings into ASCII code.

Other advantages and aspects of the present invention will become apparent upon reading the following description of the drawings and the detailed description of the invention.

### BRIEF DESCRIPTION OF THE DRAWINGS

To understand the present invention, it will now be described by way of example, with reference to the accompanying drawings in which:

FIG. 1 shows an example of the letter ‘J’ on an 8×8 grid;

FIG. 2 shows the letter ‘J’ with the coordinates mapped out on the 8×8 grid;

FIG. 3 shows the two arrays, a vertical array and a horizontal array, created after mapping the letter ‘J’;

FIG. 4 shows the two arrays after the first optimizing step of the mapped letter ‘J’ using a vertical biasing;

FIG. 5 shows a chart showing the redundancy present in FIG. 4 to assist in performing the second optimizing step of the mapped letter ‘J’;

FIG. 6 shows the two arrays after the third optimizing step of the mapped letter ‘J’ and after the entries have been sorted by length;

FIG. 7 shows a single array representing the combined arrays (optimized with a vertical bias) shown in FIG. 6;

FIG. 8 is a schematic representation of for setting up the header rows and data rows and for converting the arrays to bit strings;

FIG. 9 shows the Array of FIG. 7 converted to bit strings using the logic shown in FIG. 8;

FIG. 10 shows an intermediate step of taking the rows of FIG. 9 and converting the data strings to resultant data strings;

FIG. 11 shows a first intermediate step in the process of converting the resultant data strings of FIG. 10 to final 8-bit stings or bytes;

FIG. 12 shows a second intermediate step in the process of converting the resultant data strings of FIG. 10 to final 8-bit strings or bytes;

FIG. 13 shows third intermediate step in the process of converting the resultant data strings of FIG. 10 to final 8-bit strings or bytes;

FIG. 14 shows the final 8-bit strings set forth in a column;

FIG. 15 shows a first conversion table for ASCII and of binary code, integer/decimal equivalents and character equivalents;

FIG. 16 shows the 8-bit strings or bytes converted to a character string for the letter ‘J’; and,

FIG. 17 shows a second conversion table for ASCII and of binary code, hexadecimal equivalents and octal equivalents.

### DETAILED DESCRIPTION OF THE INVENTION

This system takes a computer representation, or image, of a signature and encodes it as a series of 8 bit integers. This system is developed as a .NET managed library for Windows deployment. In particular, the system takes an image, 1) digitally maps the image, 2) optimizes the digitalized, mapped image while compressing the data, 3) sorts the data and 3) manipulates the data, and finally 4) encodes the image into a digital bit string. As a result, the image can be represented by an ASCII byte code or other code.

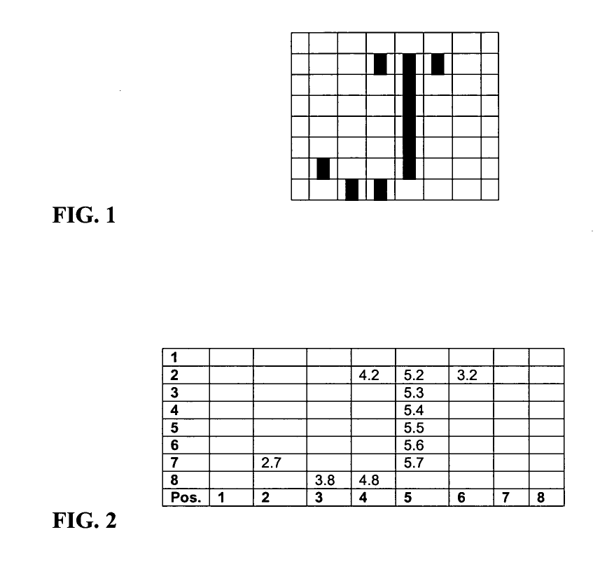

The process can be illustrated by an example, using the letter ‘J’ presented on an 8×8 grid. See FIG. 1. This letter ‘J’ can further be represented or mapped by the x-y coordinates of the grid shown in FIG. 2. For example, the distal end of the hook portion of the ‘J” is positioned at x-2 and y-7.

Step 1 (Input and Encoding)

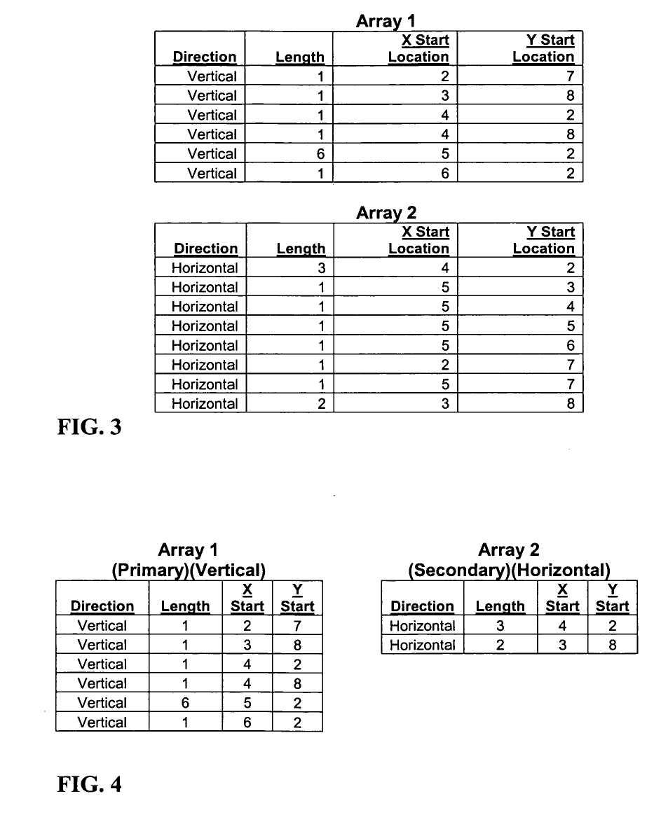

The signature is first mapped by braking-down the signature into a series of individual lines. These lines are then described and stored in two separate arrays, namely one array devoted to vertical lines and one array devoted to horizontal lines. Each line of each array consists of at least four descriptors, namely 1) direction, 2) length, 3) starting x location, and 4) starting y location. In the example shown in FIG. 3, the vertical lines are broken-out in Array 1 and the horizontal lines are broken-out in Array 2. It should be noted at this time, that the length used is the continuous length. As such, if the line is not continuous, but disjointed, such as in Column 4 of FIG. 2 and Row 6 of FIG. 2, two separate entries are made in each instant. Again, looking at the distal end of the hook portion of the ‘J’ positioned at x-2 and y-7, the description in Array 1 would be “vertical” for a vertical line, having length of “1,” with a starting x location of “2” and a starting y location of “7.” The description in Array 2 would be “horizontal” for a horizontal line, having length of “1,” with a starting x location of “2” and a starting y location of “7.” As a result, the letter ‘J’ is mapped and broken-down in the manner shown in FIG. 3.

Note Array 1 describing the horizontal lines in the Row 7 of FIG. 2, there are two entries to describe the disjointed or non-continuous horizontal lines: Horizontal-1-2-7 and Horizontal-1-5-7. Similarly, the two entries describing the disjointed or non-continuous vertical lines in Column 4 are described as: Vertical-1-4-2 and Vertical 1-4-8.

Step 2 (Running Optimizers)

After all of the vertical and horizontal lines are mapped/generated into their respective arrays, a series of optimizers are performed or run to remove redundant information.

One way to optimize the results includes the following optimizers or optimizing steps:
i) Removing all lines in one array of having a length of “one-length,” that being points;
ii) Removing all lines in another array having a length of one-length from when they are already represented by a longer line in the one array; and,
iii) Removing lines from one array when the total representation of that line is already represented by lines in another array.

Lines can be optimized with either a horizontal bias or a vertical bias. It has been found that vertical biasing is most effective when a signature has a number of long looping letters and horizontal biasing is more effective when a signature is a small group of loops followed by a long trailer.

Vertical biasing is performed by running the optimizers in the follow order:
i) Removing all single points (one-length distances) from the horizontal array;
ii) Removing all redundant single points (one-length distances) from the vertical array (those points already represented in the horizontal array); and,
iii) Removing all redundant lines from the horizontal array if such lines are already represented in the vertical array.

Horizontal biasing is completed by performing the same steps, but switching the horizontal array for the vertical arrays and visa versa.

Thus, horizontal biasing is performed by running the optimizers in the follow order:
i) Removing all single points (one-length distances) from the vertical array;
ii) Removing all redundant single points (one-length distances) from the horizontal array (those points already represented in the vertical array); and,
iii) Removing all redundant lines from the vertical array if such lines are already represented in the horizontal array.

This optimizing not only removes redundant data, it necessarily reduces or compresses the data necessary to describe the mapped image. After setting up the two arrays (vertical array (Array 1) and horizontal array (Array 2) (FIG. 3)), one runs or performs the optimizers. The example using the letter ‘J’ is optimized with a vertical biasing by the above algorithm as follows:

The Primary Array used is vertical array (Array 1) and the Secondary Array will be the horizontal array (Array 2).

Optimizer 1: Removing all single points (one-length distances) from the horizontal array. This is accomplished by removing lines with a length of one (1) from the Secondary Array (horizontal array (Array 2)). Thus, from top to bottom, Rows 2-7 are eliminated and Rows 1 and 8 remain in the horizontal array (Array 2). The resulting set is shown in as Array 2, the Secondary Array in FIG. 4. The Primary Array 1, the vertical array remains unchanged.

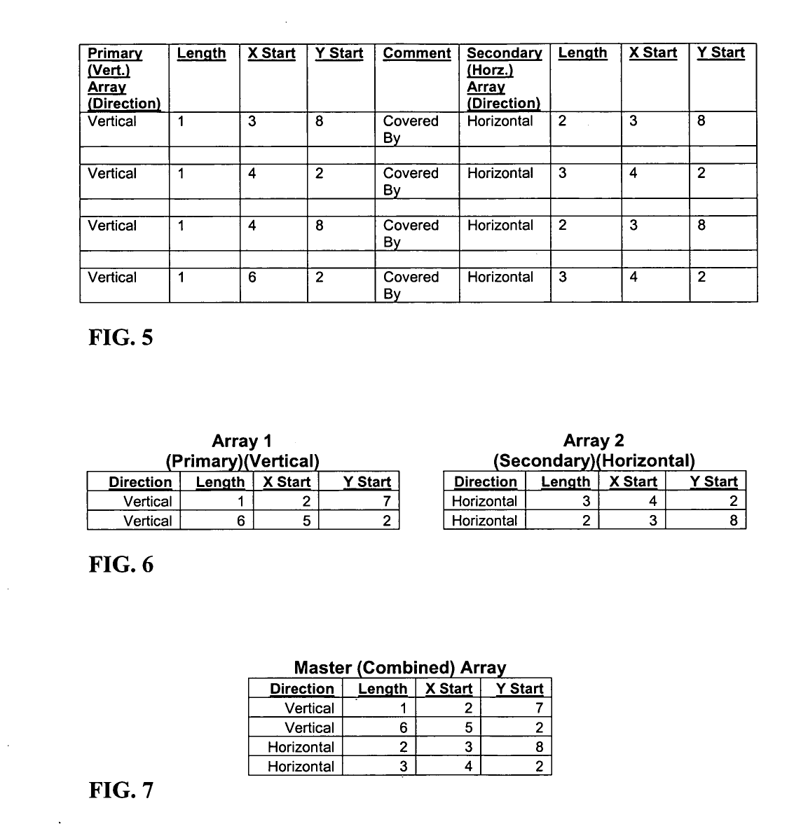

Optimizer 2: Removing all redundant single points (one-length distances) from the vertical array. In short, those points already represented in the horizontal array are removed from the vertical array. This is accomplished by removing lines with a length of one (1) from the Primary Array (vertical array (Array 1)) wherein the line is already represented by a longer line in the Secondary Array (horizontal array (Array 2)). As shown in FIG. 5, in the illustrated example of the letter ‘J,’ the system recognizes the lines in the Primary Array (vertical array), represented by longer lines in the Secondary Array (horizontal array).

Looking at Row 1 (top to bottom) in FIG. 5, the Primary Array represented by Vertical-1-3-8 is already by Secondary Array Horizontal-2-3-8. Visually, the point on the grid at 3,8 described on the Primary (vertical) Array is duplicated or covered by the line having a length of 2 starting at the point on the grid at 3,8 described on the Secondary (horizontal) Array. Similarly, in Row 2, the point on the grid at 4,2 described on the Primary (vertical) Array is duplicated by the line having a length of 3 starting at the point on the grid at 4,2 described on the Secondary (horizontal) Array. This optimization step is continued until all such duplications have been identified. As a result, from top to bottom, Rows 2, 3, 4 and 6 are eliminated and Rows 1 and 5 remain in the vertical array (Array 2). The resulting set becomes that shown in FIG. 6.

Optimizer 3: Removing all redundant lines from the horizontal array if such lines are already represented in the vertical array. This is accomplished by removing all lines from the Secondary (horizontal) Array (Array 2) where the lines are already represented by a line in the Primary (vertical) Array (Array 1).

In the illustrated example, there are no such lines falling into this category.

Step 3 (Sorting)

After the arrays are optimized, FIG. 6, they are (i) sorted from shortest length to the longest length and then (ii) combined into a Master (Combined) Array with all Primary (Vertical) Array lines (vertical lines) first, followed by all Secondary (Horizontal) Array lines (horizontal lines). The results of this sorting are shown in FIG. 7.

Step 4 (Encoding Rows)

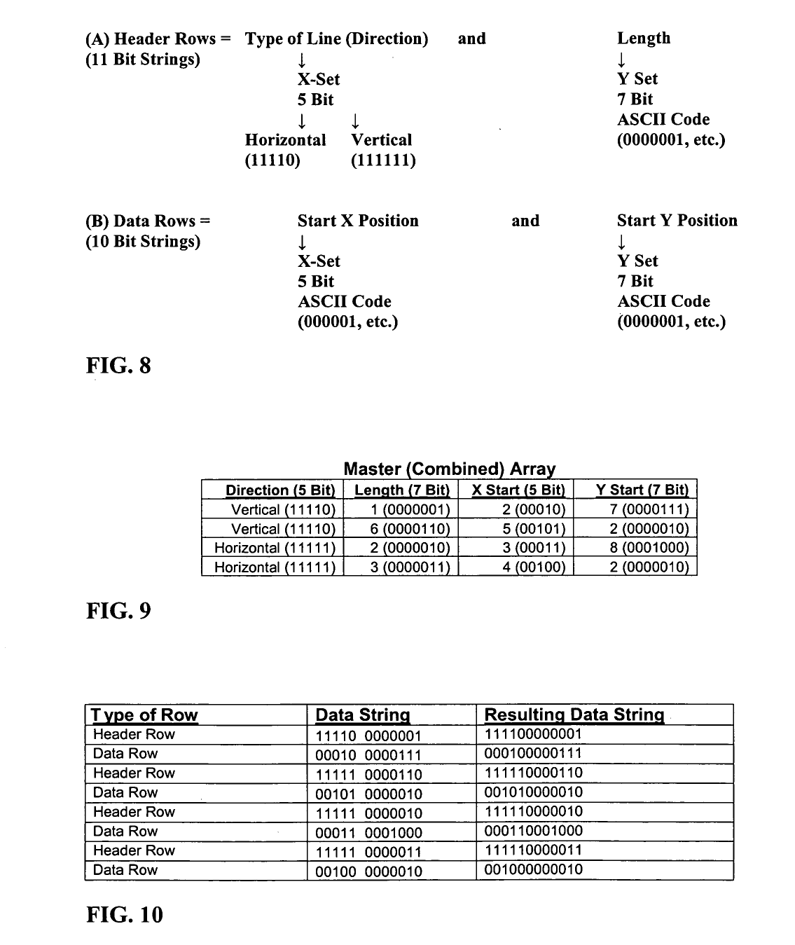

After this combining and formation of the Master (Combined) Array, the lines are encoded into encoded rows of two sets of bits. The first set of bits is the “X-Set” and the second set of bits is the “Y-Set.” See FIG. 8. To do this step, there are two types of encoded rows or bit strings or bit patterns created, that being “Header Rows” and the “Data Rows.” Each Header Row signals or identifies both the type of the line (horizontal or vertical) and the length of line (1, 2, 3, etc.) in binary code with binary strings or patterns. This is accomplished by first setting the Header Row with “X-Set” binary codes to five (5) bit numbers, strings or integers with the predetermined code for vertical lines being set at “11110” and the predetermined code for horizontal lines being set to “11111.” Accordingly, the length of each line is then stored in the Header Row by setting the “Y-Set” code to seven (7) bit strings/patterns/integers/numbers in binary code. Specifically, the length of one is represented by the seven (7) bit code 0000001. two is 0000010, three becomes 0000011, four becomes 0000100, five is 000101 and six is 0000110, seven is 0000111, etc.

Each Data Row contains the Starting X Location in the “X-Set,” and the Starting Y Location in the “Y-Set.” Each X-Set number is represented in a five (5) bit string or bit patterns and each Y-Set number is represented by a seven (7) bit string or bit patterns. The length and direction of each Data Row is thus remembered or recalled by the signaling or identifying Header Row preceding the Data Row.

Thus, using these guidelines and the American Standard Code for Information Interchange (ASCII), the above Master (Combined) Array can be converted to bytes (8 bits in each code group) as shown in FIGS. 9 and 10.

As shown in FIGS. 9, the first Header Row would signal a vertical line (11110) with a length of one (1) (0000001) resulting in the following eleven (12) bit integer Header Code—111100000001 (Shown in FIG. 10).

Each Data Row following the first Header Row would identify the X Start and Y Start for each vertical line having a length of one (1). Here, there is only one such vertical line having a length of one. It would be represented as X Start 2 (00010) and Y Start 7 (000111) resulting in a ten (12) bit integer Data Row—000100000111. (See FIG. 10).

Since there are no more vertical lines having a length of one (1), there would not be a second or subsequent Data Row under the first Header Row coded (having a length of one).

As such, a new, second Header Row must be created to signal a vertical line (11110) with a length of six (6) (0000110) resulting in the following twelve (12) bit integer Header Code—1111000000110.

The fist Data Row after this second Header Row would be represented as 5 (00101) followed by 2 (0000010), making the Data Row—001010000010.

Again, since there are no more vertical lines having a length of six (6), there would not be any further Data Rows under this second Header Row coded.

Following the above, example, the next Header Row would signal a horizontal line (11111) having a length of two (2) (0000010) making this third Header Row—111110000010.

The Data Row under this third Header Row would be 3 (00011) and 8 (0001000)—000110001000.

The fourth Header Row and Data Row thereinunder would be: Header Row (4): Horizontal line (11111) with a length of three (3) (0000011)—111110000011; Data Row (4): 4(00100) and 2 (0000010)—001000000010.

The resulting data string is shown in FIG. 10.

Step 5 (Converting to 8 Bit Integers)

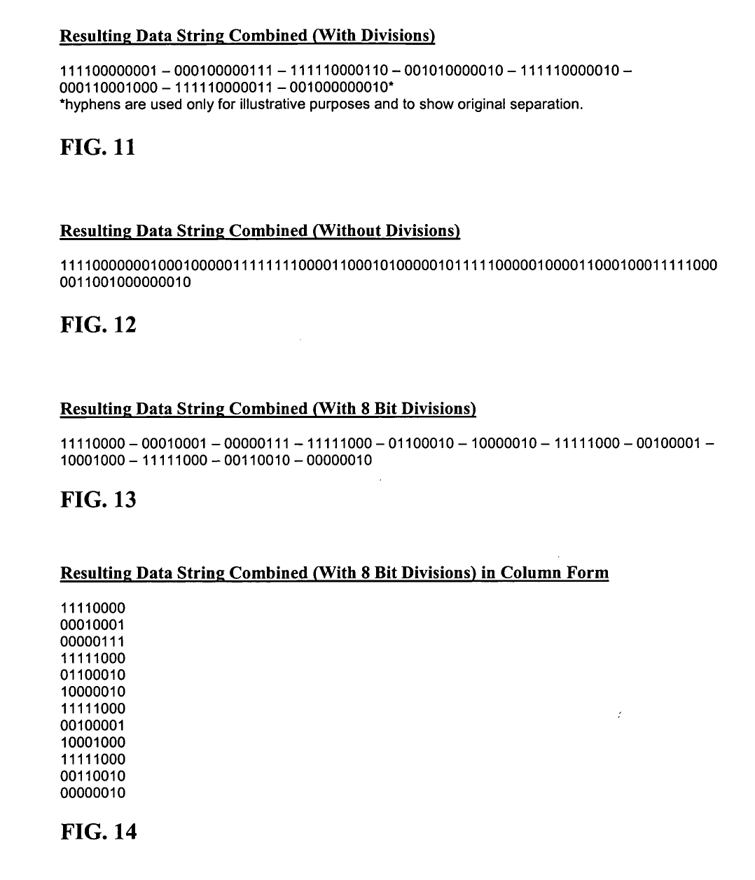

After the lines are encoded, the final step is to convert the 12 bit data strings or patterns in the Header Rows and 12 bit data strings or patterns in the Data Rows into 8 bit strings/integers/numbers/groupings. This is shown in FIGS. 11-14. Once in 8 bit groups, the string can be converted to bytes for file storage and an error check. It should be noted an error correction, such as by example the well-known industry standard Reed-Solomon encoding, can be added.

The conversion is accomplished by taking the Header Rows and Data Rows, in order, and forming a single string (FIGS. 11 and 12). Once this single string is created, the string is broken-up into eight (8) bit groups (FIG. 13). Each eight (8) bit group is then converted to numbers or bytes, using standard ASCII character conversion.

If when the single string (FIG. 11) is broken up into eight (8) bit groups and there is a remainder (e.g., the entire string is not divisible by 8), the remainder is converted into an eight bit group by adding zeros (0) to the end thereof. A remainder is defined as any remaining group of bits with a number of bits less than eight (8) after the entire string has been broken-down into eight bit strings. For example, if the remainder is a string of four bits, such as “0011,” it would be converted to “00110000” by adding four zeros to the right of the remainder. As such, the reminder becomes a single byte or eight bit string. By way of another example, if the remainder is a string of six bits, such as “010101,” it would be converted to “01010100” by adding two zeros to the right of the remainder. As such, the reminder becomes a single byte or eight bit string.

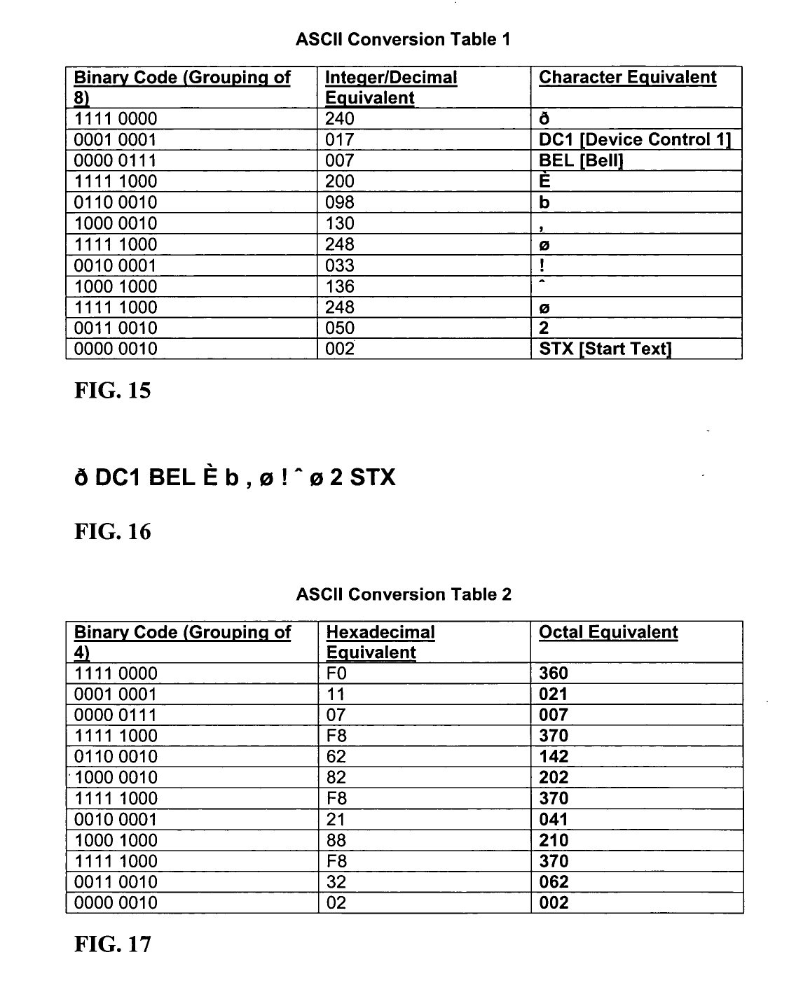

The final conversion of the letter ‘J’ is shown in the Conversion Table of FIG. 15 (integer/decimal and character equivalents) and FIG. 17 (hexadecimal and octal equivalents. Thus, the image of the letter ‘J’ can be represented by the byte character string of FIG. 16. Similarly, the letter ‘J’ can be represented in a integer/decimal string, hexadecimal string, octal string or octet strings.

The encoded writing or signature can be decoded by reversing the above process or other conventional means. The ASCII character string (FIG. 16), or whatever string is being used, can be converted to bytes (binary code in groupings of 8)(FIG. 15), further converted to a single data string (FIG. 12), and further manipulated to eventually determine the original line configuration (FIG. 1). It should be noted that the use of zeroing the remainder to get to total last bit string of eight will not affect the decoding as the additional zeros will be recognized and discarded.

It is recognized that while the grid above is shown to be 8×8, it can be other sizes, and that the grid numbering system is shown as going from top to bottom and left to right, it can be different. Similarly, other steps can be performed differently. The important component is consistency.

It is further recognized that while the discussion has been focused on a single letter, the above system can be followed to encode or decode any texts, such as handwritten or typed writings.

As used herein, the terms “first,” “second,” “third,” etc. are for illustrative purposes only and are not intended to limit the embodiments in any way. Additionally, the term “plurality” as used herein is intended to indicate any number greater than one, either disjunctively or conjunctively as necessary, up to an infinite number.

While the specific embodiments have been illustrated and described, numerous modifications can be made without significantly departing from the spirit of the invention, and the scope of protection is only limited by the scope of the accompanying Claims.

We claim:

1. A method of encoding markings having a plurality of lines therein comprising the steps of:
a) mapping the markings;
b) sorting the mapped markings;
c) optimizing the sorted mapped markings to reduce redundant information; and,
d) converting the optimized and sorted mapped markings into code.

2. The method of claim 1 wherein the markings includes handwriting.

3. The method of claim 1 wherein the markings includes a handwritten signature.

4. The method of claim 1 wherein the step of mapping the markings includes the steps of producing:
i) a first data set of line directions for each line,
ii) a second data set of start location coordinates for each line and line direction, and
iii) a third data set of lengths for each line, each line direction, and each start location coordinates.

5. The method of claim 4 wherein the step of sorting the mapped markings includes the step of producing at least two arrays distinguished from one another by at least one characteristic contained in one of the data sets, with each array containing data from the first, second and third data sets.

6. The method of claim 5 wherein the step of optimizing the sorted mapped markings includes the steps of:
i) ranking the at least two arrays so as to create a first array and at least one other array,
ii) removing data from the at least one other array based upon a first pre-established criteria,
iii) removing data from the first array duplicated in the at least one other array and is based upon a second pre-established criteria, and
iv) removing data from the at least one other array duplicated in the first array.

7. The method of claim 6 wherein the step of converting the optimized and sorted mapped markings into a code includes the steps of:
i) sorting each array based upon data in the third data set,
ii) combining the arrays to create a single array,
iii) converting the data to a plurality of bit strings based upon the following criteria:
a) creating first bit strings based upon data in the first data set,
b) generating second bit strings based upon data in the third data set, and
c) generating third bit strings based upon data in the second data set,
iv) combining the first bit strings, second bit strings and third bit strings for the single array to create a cumulative bit string,
v) grouping the cumulative bit string into separate substrings, and
vi) converting the separate substrings into ASCII code.

8. The method of claim 1 wherein:
a) the step of mapping the markings includes the steps of producing:
i) a first data set of line directions for each line,
ii) a second data set of start location coordinates for each line and line direction, and
iii) a third data set of lengths for each line, each line direction, and each start location coordinates;
b) the step of sorting the mapped markings includes the step of producing:
i) at least two arrays distinguished from one another by at least one characteristic contained in one of the data sets, with each array containing data from the first, second and third data sets;
c) the step of optimizing the sorted mapped markings includes the steps of:
i) ranking the at least two arrays so as to create a first array and at least one other array,
ii) removing data from the at least one other array based upon a first pre-established criteria,
iii) removing data from the first array duplicated in the at least one other array and is based upon a second pre-established criteria, and
iv) removing data from the at least one other array duplicated in the first array; and,
d) the step of converting the optimized and sorted mapped markings into a code includes the steps of:
i) sorting each array based upon data in the third data set,
ii) combining the arrays to create a single array,
iii) converting the data to a plurality of bit strings based upon the following criteria:
a) creating first bit strings based upon data in the first data set,
b) generating second bit strings based upon data in the third data set, and
c) generating third bit strings based upon data in the second data set,
iv) combining the first bit strings, second bit strings and third bit strings for the single array to create a cumulative bit string,
v) grouping the cumulative bit string into separate substrings, and
vi) converting the separate substrings into ASCII code.

9. A method of encoding markings having a plurality of lines therein comprising the steps of:
a) mapping the markings for each line by creating a line profile for each line;
b) sorting the line profiles into at least two arrays distinguished from each other by at least one characteristic contained in each line profile;
c) optimizing the at least two arrays by reducing redundant line profiles; and,
d) converting the at least two arrays into code.

10. The method of claim 9 wherein the markings includes handwriting.

11. The method of claim 9 wherein the markings includes a handwritten signature.

12. The method of claim 9 wherein:
a) each line profile comprises a line direction, a line start location coordinates and a line length;
b) the one characteristic is the line direction so that each array includes line profiles having the same line directions; and
c) the step of optimizing the at least two arrays by reducing redundant line profiles includes the steps of
i) ranking the at least two arrays so as to create a primary array and at least one secondary array,
ii) removing each line profile from the secondary array(s) having a line length of one,
iii) removing each line profile from the primary array having a line length of one and is duplicated in the secondary array(s), and
iv) removing each line profile from the secondary array(s) that is duplicated in the primary array.

13. The method of claim 12 wherein the step of converting the at least two arrays into code includes the steps of:
i) sorting each array based upon line length,
ii) combining the arrays by stacking the primary array and then the secondary array(s) to create a single array,
iii) converting the line profiles to a plurality of bit patterns of a pre-selected length,
iv) combining the bit patterns of the single array to create a cumulative bit string,
v) grouping the cumulative bit string into separate substrings, and
vi) converting the separate substrings into ASCII code.

14. The method of claim 9 wherein:
a) each line profile comprises a line direction, a line start location coordinates and a line length;
b) the one characteristic is the line direction so that each array includes line profiles having the same line directions;
c) the step of optimizing the at least two arrays by reducing redundant line profiles includes the steps of:
i) ranking the at least two arrays so as to create a primary array and at least one secondary array,
ii) removing each line profile from the secondary array(s) having a line length of one,
iii) removing each line profile from the primary array having a line length of one and is duplicated in the secondary array(s), and
iv) removing each line profile from the secondary array(s) that is duplicated in the primary array; and,
d) the step of converting the at least two arrays into code includes the steps of
i) sorting each array based upon line length,
ii) combining the arrays by stacking the primary array and then the secondary array(s) to create a single array,
iii) converting the line profiles to a plurality of bit patterns of a pre-selected length,
iv) combining the bit patterns of the single array to create a cumulative bit string,
v) grouping the cumulative bit string into separate substrings, and
vi) converting the separate substrings into ASCII code.
